(19) United States
(12) Patent Application Publication
(10) Pub. No.: US 2022/0132762 A1
(43) Pub. Date: May 5, 2022

(54) Vertical Modular Hydroponic Plant Growing System and Kit for Same

(71) Applicant: EXO, LLC, Merritt Island, FL (US)

(72) Inventor: Nicole Madeux, Merrritt Island, FL (US)

(21) Appl. No.: 17/646,828

(22) Filed: Jan. 3, 2022

Related U.S. Application Data
(60) Provisional application No. 63/108,379, filed on Nov. 1, 2020.

(51) Int. Cl. A01G 31/06; A01G 9/02

(52) U.S. Cl. CPC A01G 31/06; A01G 9/023

(57) ABSTRACT

A plant growing system including a base assembly, a pumping module, a plurality of vertical stacking units, each vertical stacking unit of the plurality of stacking units including sidewalls defining an interior vertical channel, an attachment section, and a plant receiving member that includes a plant-receiving aperture to permit a plant module to be positioned therein and extend into the interior vertical channel such that a portion of the plant module is in fluidic communication with the interior vertical channel, and an irrigation module comprising sidewalls, a center member having one or more apertures, an inlet port, and an outlet port.

### RELATED APPLICATIONS

This application claims priority under 35 U.S.C. § 119(e) of U.S. Provisional Patent Application Ser. No. 63/108,379 filed on Nov. 1, 2020. The content of this application is incorporated herein by reference.

### FIELD OF THE INVENTION

The present invention relates to vertical modular hydroponic plant growing systems and kits for the same.

### BACKGROUND OF THE INVENTION

Hydroponically-grown plants, where a nutrient-enriched water-based fluid is provided to the roots of plants to facilitate growth, are advantageous to plants planted outdoors to take advantage of climate controls commonly used in indoor settings and to prevent pests from negatively affecting the growth of the plants. However, traditional hydroponic systems tend to rely on a trough of nutrient-enriched fluid into which the plants' roots may grow. Such systems tend to occupy a large area of floorspace. In indoor settings where floorspace can be limited, such systems that require large amounts of floorspace are undesirable. Accordingly, there is a need in the art for a hydroponic system that reduces the amount of floorspace occupied by the system.

Where prior hydroponic systems have attempted to minimize floorspace, such systems tend to rely on tubing systems that provide nutrient-enriched fluid to the plants individually, i.e. each plant has a dedicated tube to provide the fluid to the plant. Such solutions are disadvantageous as the tubes for individual plants tend to be narrow and prone to clogging and/or occlusion. Moreover, similar systems tend to be limited in their ability to expand/include more locations for additional plants, as additional piping must be attached and routed to the expanded locations. Accordingly, there is a need in the art for a hydroponic system that facilitates the expansion of the system over time and reduces the complexity of tubing to avoid performance reductions.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a vertical modular hydroponic plant growing system and a kit comprising the same. In some embodiments, the vertical modular hydroponic plant growing system may include a base assembly that may include a nutrient reservoir, and an upper attachment member. The system also includes a pumping module may include: a fluid pump operable to pump fluid, and a pump tube configured to attach to the fluid pump at a first end and permit fluid pumped by the fluid pump to flow therethrough and exit at a second end. The system also includes a plurality of vertical stacking units, each vertical stacking unit of the plurality of stacking units may include: one or more sidewalls defining an interior vertical channel, each sidewall may include an attachment section at a lower end thereof configured to interface with one of the upper attachment member of the base assembly and an upper portion of the sidewalls of a vertical stacking unit to removably attach the vertical stacking unit thereto; a plant receiving member extending radially outward from a sidewall, the plant receiving member may include a plant-receiving aperture configured to permit a plant module to be positioned therein and grow outward therefrom and extend into the interior vertical channel such that a portion of the plant module is in fluidic communication with the interior vertical channel. The system also includes an irrigation module configured to attach to a vertical stacking unit and may include: one or more sidewalls configured to interface with the sidewalls of a vertical stacking unit, thereby removably attaching the irrigation module to the vertical stacking unit; a center member may include one or more apertures; an inlet port extending downward from the center member and configured to facilitate the removable attachment of the second end of the pump tube thereto; and an outlet port extending upward from the center member and positioned in fluidic communication with the inlet port and configured to permit fluid flowing into the inlet pump to flow out the outlet port. The system also includes where the interior vertical channel of each vertical stacking unit cooperates to define a contiguous interior channel of the system. The system also includes where fluid flowing out of the outlet port flows onto the upper surface of the center member and through the one or more apertures thereof into the contiguous interior channel.

Implementations may include one or more of the following features. An upper surface of the center member is bounded by the one or more sidewalls of the irrigation module. The nutrient reservoir may include a lower wall and a plurality of sidewalls, and the upper attachment member is configured to removably attach to an upper end of the plurality of sidewalls of the nutrient reservoir.

The upper attachment member may include a first section may include an attachment structure configured to facilitate the removable attachment of a vertical stacking unit thereto and defining an aperture, and a second section that is one of separate from the first section and rotatably attached to the first section, where the upper attachment member obstructs an upper opening of the nutrient reservoir when the second section is in a closed position and permits access to the upper opening of the nutrient reservoir when the second section is in an open position, and where the aperture of the first section is configured to permit the pump tube to pass therethrough and into the contiguous interior channel.

The attachment section of the one or more sidewalls of the vertical stacking units have an outer dimension that is less than an inner dimension of the upper portion of the sidewalls of the vertical stacking units. The irrigation module further may include a cover attachment member, the system may include a cover member configured to rotatably attach to the cover attachment member and be positionable to interface with an upper section of the sidewalls of the irrigation module and prevent the unintentional expulsion of fluid through an open upper section of the irrigation module.

The center member may include a first plurality of apertures positioned proximate to the sidewalls of the irrigation module and a second plurality of apertures positioned proximate to the outlet port.

The system may include a distribution member configured to removably attach to the outlet port and to deflect fluid emerging from the outlet port in a substantially uniform distribution pattern.

The plant receiving member may be integrally formed with the sidewall of the vertical stacking unit. The plant receiving member may include a body member extending upward and outward from an outer surface of a sidewall of the vertical stacking unit and defining a passageway through which the plant module may be positioned and extend into the interior vertical channel of the vertical stacking unit and an interfacing surface member extending outward and downward from the same outer surface of the sidewall of the vertical stacking unit as the body member. The interfacing surface may include an upper surface thereof defining the plant-receiving aperture and configured to interface with a surface of the plant module to prevent the plant module from sliding entirely into the interior vertical channel, thereby suspending the plant module in the plant receiving member. Each vertical stacking unit may include a plurality of plant receiving members equal in number to the number of sidewalls may include by the one or more sidewalls of the vertical stacking unit.

Another embodiment of the invention is directed to a vertical modular hydroponic plant growing system kit also includes a container. The kit also includes a base assembly may include: a nutrient reservoir, and an upper attachment member. The kit also includes a pumping module may include: a fluid pump operable to pump fluid, and a pump tube configured to attach to the fluid pump at a first end and permit fluid pumped by the fluid pump to flow therethrough and exit at a second end. The kit also includes a plurality of vertical stacking units, each vertical stacking unit of the plurality of stacking units may include: one or more sidewalls defining an interior vertical channel, each sidewall may include an attachment section at a lower end thereof configured to interface with one of the upper attachment member of the base assembly and an upper portion of the sidewalls of a vertical stacking unit to removably attach the vertical stacking unit thereto; a plant receiving member extending radially outward from a sidewall, the plant receiving member may include a plant-receiving aperture configured to permit a plant module to be positioned therein and grow outward therefrom and extend into the interior vertical channel such that a portion of the plant module is in fluidic communication with the interior vertical channel. The kit also includes an irrigation module configured to attach to a vertical stacking unit and may include: one or more sidewalls configured to interface with the sidewalls of a vertical stacking unit, thereby removably attaching the irrigation module to the vertical stacking unit; a center member may include one or more apertures; an inlet port extending downward from the center member and configured to facilitate the removable attachment of the second end of the pump tube thereto. The kit also includes an outlet port extending upward from the center member and positioned in fluidic communication with the inlet port and configured to permit fluid flowing into the inlet pump to flow out the outlet port. The kit also includes a plurality of plant modules, each plant module may include: a frame, a porous retaining material supported by the frame, a plant growth medium positioned within and contained by the porous retaining material, and a plant seed positioned within the plant growth medium.

Implementations of the kit may include one or more of the following features. The kit where the irrigation module further may include a cover attachment member, and the kit may include a distribution member configured to removably attach to the outlet port and to deflect fluid emerging from the outlet port in a substantially uniform distribution pattern, and a cover member configured to rotatably attach to the cover attachment member and be positionable to interface with an upper section of the sidewalls of the irrigation module and prevent the unintentional expulsion of fluid through an open upper section of the irrigation module.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a vertical modular hydroponic plant growing system according to an embodiment of the present invention.

FIGS. 2a-b are perspective and side sectional views of a base apparatus of the system of FIG. 1.

FIGS. 3a-b are upper and lower perspective views of an upper attachment member of the system of FIG. 1.

FIGS. 4a-c are upper perspective, top plan, and side sectional views of a vertical stacking unit of the system of FIG. 1.

FIGS. 5a-c are upper perspective and lower plan views of an irrigation module of the system of FIG. 1 and a lower view of the irrigation module with the pump tube attached thereto.

FIG. 6 is an upper perspective view of a portion of the system of FIG. 1.

FIG. 7 is a perspective view of a plant module according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

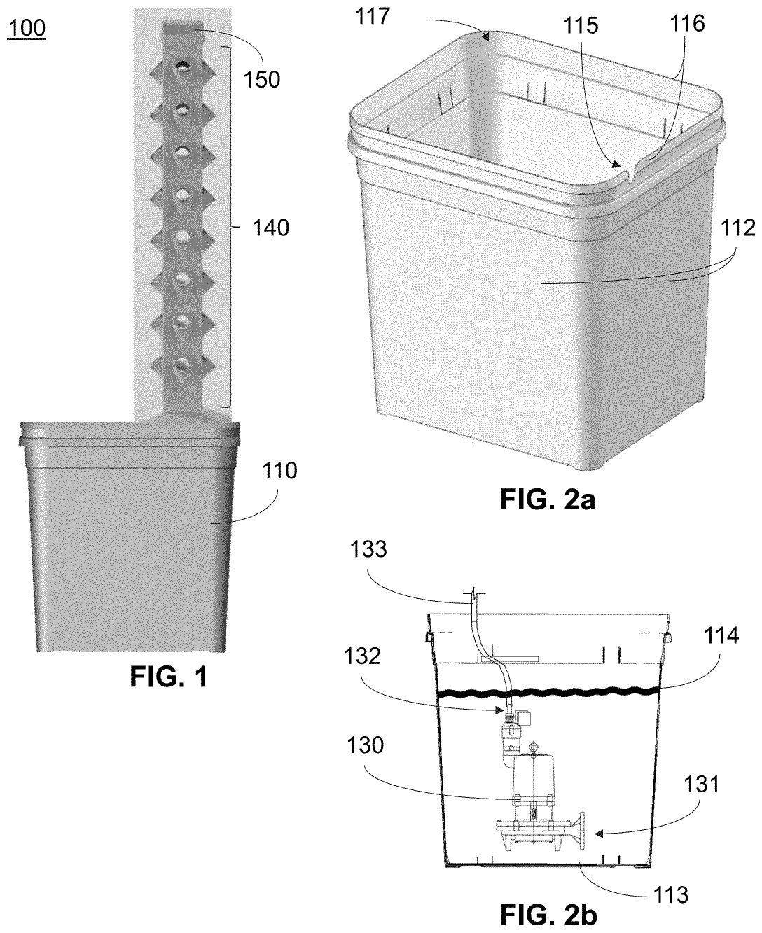

An embodiment of the invention, as shown and described by the various figures and accompanying text, provides a vertical modular hydroponic plant growing system. Referring now to FIGS. 1-6, a system 100 according to an embodiment of the invention is presented. The system 100 may comprise a base assembly 110, a pumping module 130, a plurality of vertical stacking units 140, and an irrigation module 150.

The base apparatus 110 may comprise a nutrient reservoir 111. The nutrient reservoir 111 may be bounded by one or more sidewalls 112 of the base apparatus 110 and a lower wall 113 to define a fluid-tight volume within which an irrigating fluid 114 may be retained, such as a nutrient-enriched water-based fluid. One or more of the sidewalls 112 may comprise a cutout 115 to permit cabling associated with the pump module 130 to pass therethrough. The sidewalls 111 comprise an upper end 116 that defines an upper opening 117 of the base apparatus 110. The cutout 115 may be formed in an upper end 116 of one of the sidewalls 112.

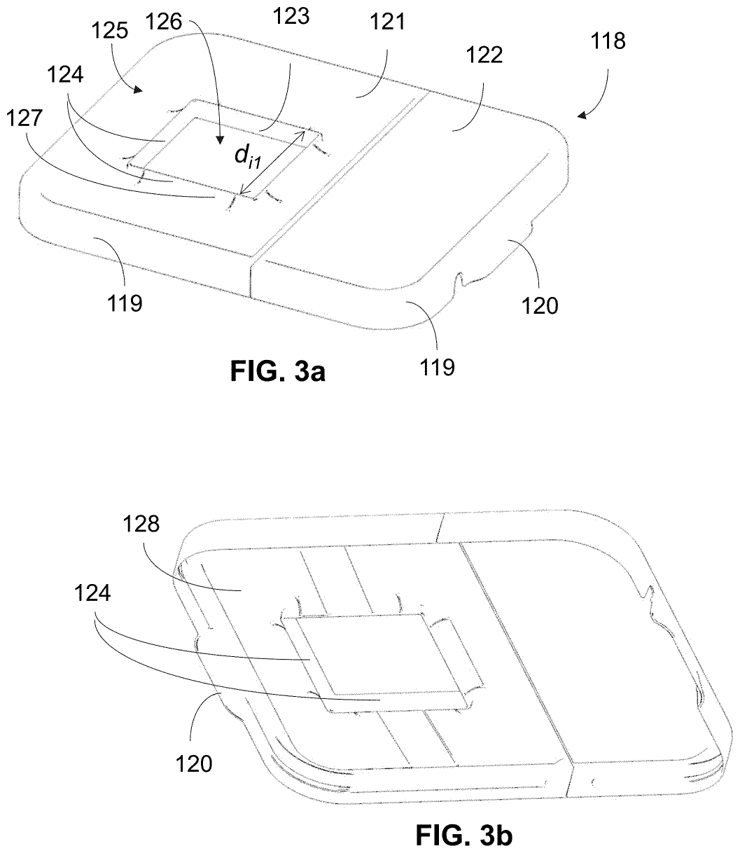

The base apparatus 110 may further comprise an upper attachment member 118, as shown in FIGS. 3a-b. The upper attachment member 118 may be configured to removably attach to the upper end 116 of the sidewalls 112. The upper attachment member may comprise sidewalls 119 and one or more handles 120 formed in the sidewalls 119 to facilitate detachment from the sidewalls 112. The upper attachment member 118 may comprise a first section 121 and a second section 122. The first and second sections 121, 122 may be one of independent and separately removably attachable to the sidewalls 112 from each other or rotatably coupled to each other. Where rotatably coupled, any means of rotatable coupling as is known in the art may be used, including, but not limited to, hinges, a flexible hinged section of an integrally formed member, and the like.

When attached to the nutrient reservoir 111, the upper attachment member 118 may generally obstruct the upper opening 117. The upper opening 117 may be rendered accessible by transitioning the second section 122 from a first close position to an open position. Such transitioning may be accomplished by detaching the second section 122 from the sidewall 112 of the nutrient reservoir 111 by manipulating a handle 120 comprised by the second section 122.

The first section 121 may be configured to permit a pump tube 132 coupled to the pump module 130 to pass through the first section 121. To accomplish such, in some embodiments, the first section 121 may comprise an attachment structure 123. The attachment structure 123 may be configured to facilitate the removable attachment of a vertical stacking unit of the plurality of vertical stacking units 140 thereto. The attachment structure 123 may comprise a plurality of walls 124 extending upward from an upper surface 125 of the first section 121. The walls 124 may define an aperture 126 through which items may pass from within the nutrient reservoir 111 through the aperture 126 and into the space above the aperture 126 as will be discussed in further detail. The walls 124 may include a slope 127 extending outward from the aperture 127 that may facilitate coupling with a vertical stacking member of the plurality of vertical stacking members 130. The walls 124 may define a shape of the aperture 126, and that shape may comply with a shape of the plurality of vertical stacking members 130. In some embodiments the walls 124 may also extend downward from a lower surface 128 of the first section 121. Pump tubing 133 may be coupled to the outlet 132 and a lumen thereof positioned in fluidic communication with the outlet 132, such that fluid pumped out the outlet 132 may flow through the pump tubing 133. The aperture 126 may have an inner dimension dᵢ₁ that may be configured to permit a portion of a vertical stacking unit of the plurality of vertical stacking units 140 to be positioned at least partially there within, thereby removably attaching the vertical stacking unit to the upper attachment member 118.

The pump module 130 may be positioned in fluidic communication with the nutrient reservoir 111. In the present embodiment, the pump module 130 may be positioned within the nutrient reservoir 111. Accordingly, any type of submersible pump as is known in the art is contemplated and included within the scope of the invention. A power supply cord (not shown) may extend from the pump module 130 through the cutout 115 and connect to a power source to power the operation of the pump module 130. The pump module 130 may comprise an inlet 131 and an outlet 132. When the pump module 130 is operating, fluid 114 within the nutrient reservoir 111 may be drawn into the inlet 131 and pumped out of the outlet 132. As mentioned above, the pump tubing 133 may be positioned so as to extend through the aperture 126 out of the nutrient reservoir 111. It is contemplated and included in the scope of the invention that the pump module 130 may be positioned outside the nutrient reservoir 111 and that a second pump tube may be coupled to the inlet at one end and have an opposite end positioned either within the nutrient reservoir 111 or coupled to a port (not shown) that permits fluid 114 to flow out of the nutrient reservoir 111.

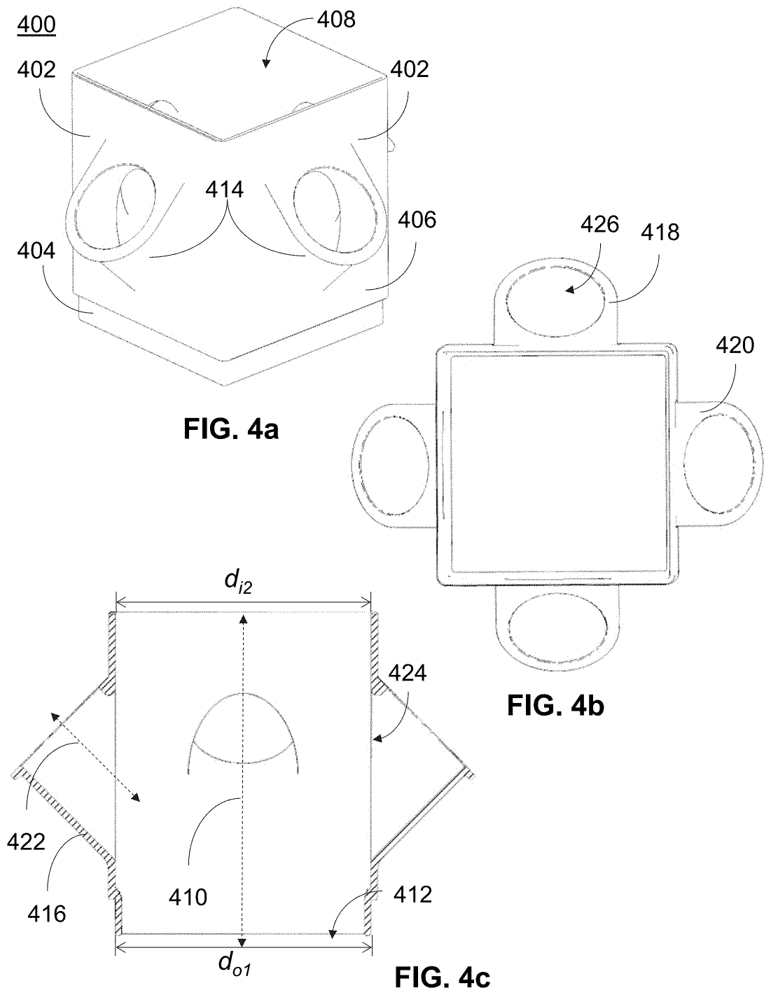

Referring now specifically to FIGS. 4a-c, a vertical stacking unit 400 comprised by the plurality of vertical stacking units 140 is shown in detail. The plurality of vertical stacking units 140 may comprise any number of vertical stacking units 400. Each vertical stacking unit 400 is configured to be modular and replaceable with another vertical stacking unit 400. The vertical stacking unit 400 may be configured to removably attach to at least one of an adjacent vertical stacking unit 400 positioned either above or below the instant vertical stacking unit 400, the attachment structure 123 of the base apparatus 110, and the irrigation module 150. As shown in FIG. 1, a system 100 comprising eight vertical stacking units 400 is presented. A system 100 comprising any number of vertical stacking units is contemplated and included within the scope of the invention.

The vertical stacking unit 400 may comprise a plurality of sidewalls 402. Any number of sidewalls 402 is contemplated and included within the scope of the invention. In the present embodiment the vertical stacking unit 400 comprises four sidewalls 402. The sidewalls 402 may define a shape of the vertical stacking unit. In the present embodiment the sidewalls 402 cooperate to define a square shape. Any regular and non-regular geometric shape is contemplated and included within the scope of the invention, including, but not limited to, circles, ellipses, triangles, rectangles, pentagons, hexagons, and the like.

The sidewalls 402 may comprise a lower section 404 and an upper section 406. The lower section 404 may be configured to be positioned within each of the upper section 406 of an adjacent vertical stacking unit 400 and the aperture 126 of the attachment structure 123. The lower section 404 may define an outer dimension dₒ₁ and the upper section may define an inner dimension dᵢ₂. Inner dimension dᵢ₂ may be greater than outer dimension dₒ₁ so that lower section 404 may be positioned within an aperture 408 defined by upper section 406, thereby coupling adjacent vertical stacking units 400. In some embodiments inner dimension dᵢ₂ may be equal to inner dimension dᵢ₁.

The plurality of sidewalls 402 may cooperate to define an interior vertical channel 410. The interior vertical channel 410 may extend through a vertical length of the vertical stacking unit 400 between the aperture 408 defined by the upper section and an aperture 412 defined by the lower section 404. The interior vertical channel 410 may be configured to enable fluid flowing in through the aperture 408 of the upper section 406 through the interior vertical channel 410 and out the aperture 412 of the lower section. Similarly, the interior vertical channel 410 may permit the pump tube 133 to pass through the aperture 412 of the lower section 406, through the interior vertical channel 410 and out the aperture 408 of the upper section 406. The interior vertical channels 410 of each vertical stacking unit 400 of the plurality of vertical stacking units 140 may cooperate to define a contiguous interior channel of the system 100. The contiguous interior channel may enable the pump tube 133 to extend through the aperture 123, up through the contiguous interior channel, and connect to the irrigation module 150. Similarly, fluid flowing out of the irrigation module as will be discussed in detail below may flow down through the contiguous interior channel, being absorbed by plant modules as will be discussed in greater detail below. Moreover, fluid flowing through the interior vertical channel 410 of the vertical stacking unit 400 that is attached to the attachment section 123 of the upper attachment member 118 may flow into the nutrient reservoir 112 for reuse.

The vertical stacking unit 400 may further comprise a plurality of plant receiving members 414. In some embodiments the vertical stacking unit 400 may comprise a number of plant receiving members 414 equal to the number of sidewalls 402. In some embodiments, the vertical stacking unit 400 may comprise a number of plant receiving members 414 fewer than the number of sidewalls 402. The plant receiving members 414 may extend outward from an outer surface of the sidewalls 402. In some embodiments the plant receiving members 414 may be integrally formed with the sidewalls 402 as a single monolithic unit. In other embodiments the plant receiving members may be formed separately and attached to the sidewalls 402 by any means or method as is known in the art, including, but not limited to, adhesives, welding, use of fasteners, and the like.

The plant receiving members may comprise a body member 416 and an interfacing surface member 418 comprising an upper surface 420. The body member 416 may define plant module channel 422 configured to permit a plant module to be positioned there within. The sidewall 402 may further comprise a plant aperture 424 configured to permit a plant module to pass there through and extend into the interior vertical channel 410. The interfacing surface member 418 may define a plant-receiving aperture 426 configured to permit a plant module to be positioned there through and extend into the plant module channel 422, through the plant aperture 424, and into the interior vertical channel 410. The upper surface 420 may be configured to interface with a structure of a plant module to prevent the entirety of the plant module from passing through the plant-receiving aperture 426 and falling into the interior vertical channel 410.

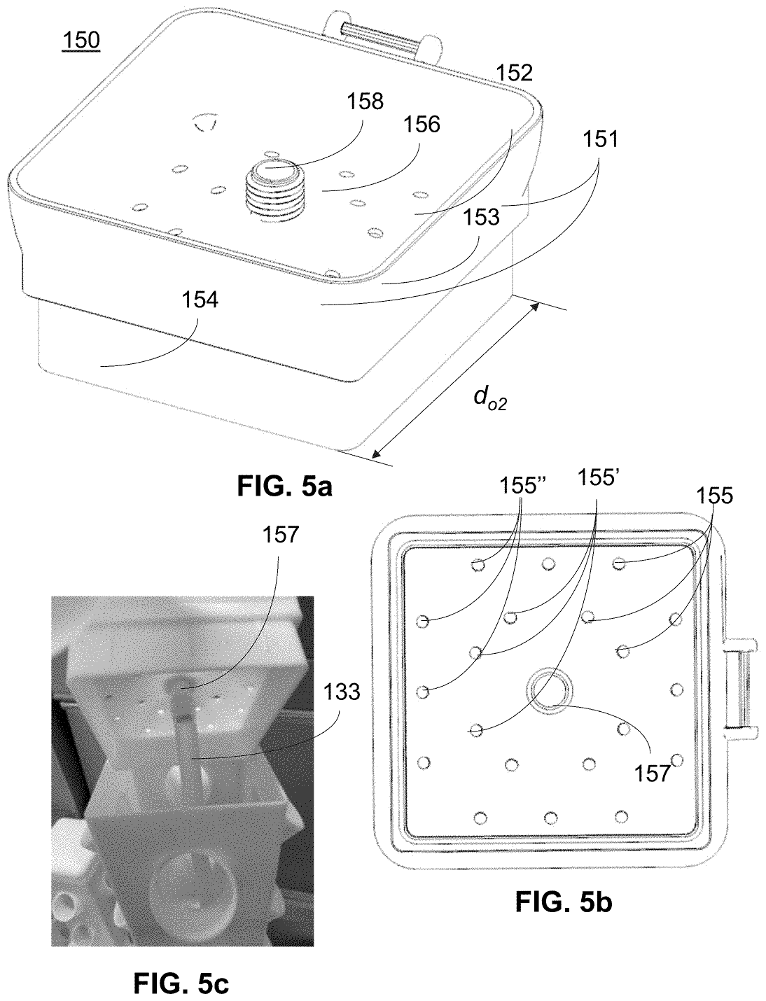

Referring now to FIGS. 5a-c, additional aspects of the irrigation module 150 are presented. The irrigation module may comprise one or more sidewalls 151, a center member 152, an inlet port 157, and an outlet port 158. The sidewalls 151 may be attached to a periphery of the center member 152. In some embodiments, the sidewalls 151 and the center member 152 may be integrally formed as a single structure. In other embodiments that sidewalls may be formed separately and attached thereafter by any means as is known in the art. In such embodiments, a gasket (not shown) may be positioned between the sidewalls 151 and the center member to prevent fluid from leaking there between. Furthermore, the upper section 153 of the sidewalls 151 may prevent fluid from spilling over the side of the center member 151.

The sidewalls 151 may comprise an upper section 153 and a lower section 154. The lower section 154 may be configured to have an outer dimension doe that is less than the inner dimension dᵢ₂ of the vertical stacking members 400 such that irrigation module may be removably attached to a topmost vertical stacking member 400 of the plurality of vertical stacking members 140, as shown in FIG. 1. The sidewalls 151 may define the shape of the irrigation module, which may comply with the shape for the vertical stacking members 400. In some embodiments, the upper section 154 may extend outward to have an outer dimension greater than a maximum outer dimension of the vertical stacking unit 400.

The center member 151 may comprise a one or more apertures 155. The apertures 155 may be formed through a thickness of the center member 151 and may be configured to permit the nutrient-enriched fluid to flow therethrough. The apertures 155 may be distributed about the center member 151. The center member 151 may be crowned, being configured such that an upper surface 156 thereof is raised at its center and lowered at its edges. The center member 151 may comprise a first set of apertures 155′ positioned proximate to the outlet port 158 and a second set of apertures 155″ positioned proximate to the sidewalls 151.

The inlet port 157 may extend downward from the center member 151 and be configured to connect with the pump tube 133 to establish fluidic communication therewith. When connected, the pump module 131 may pump the fluid 114 through the pump tube 133 into the inlet port 157. The outlet port 158 may extend upward from the center member 151 and be positioned in fluidic communication with the inlet port 157. Fluid 114 pumped into the inlet port 157 may be expelled out the outlet port 158 and fall onto the upper surface 156 of the center member 151 and flow through the apertures 155 into the contiguous interior channel. There, the fluid may descend and be absorbed by plant modules placed in the plant receiving members 414 or flow back into the nutrient reservoir 111. The inlet port 157 may be configured to facilitate removable attachment of the pump tube 133 thereto. Such configurations include, but are not limited to, threading, ridges, keyed fits, interference fits, and the like. Similarly, the outlet port 158 may be configured to facilitate removable attachment of a distribution member (not shown) thereto. The distribution member may be configured to distribute fluid exiting the outlet port in a substantially uniform manner and to prevent the fluid from attaining an undesirable height, which may cause splashing/splattering when the fluid lands on the center member 151.

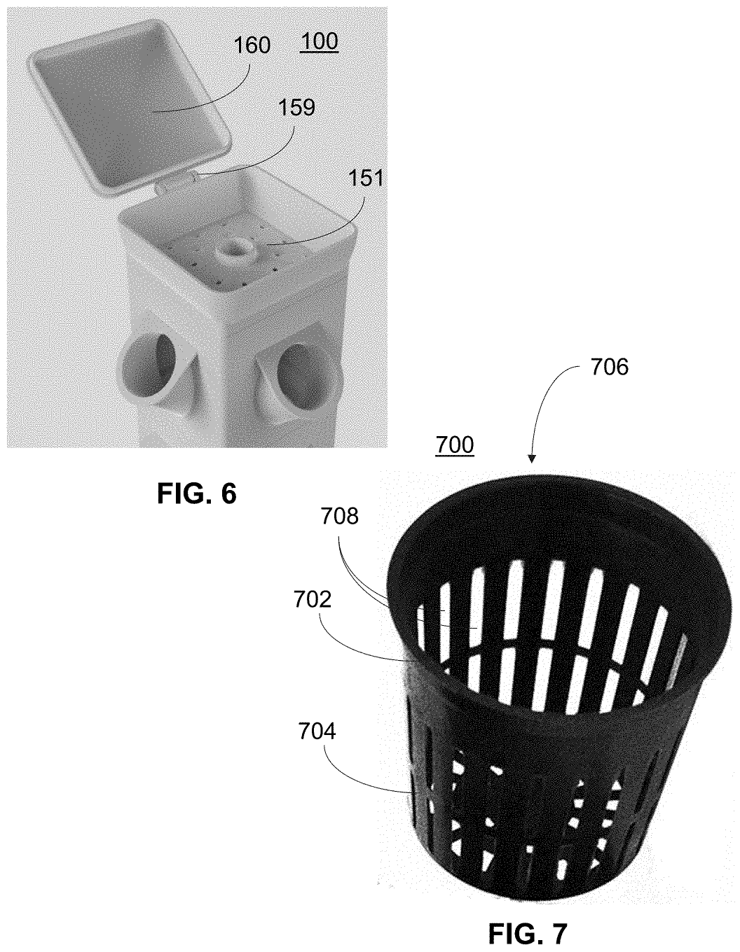

Referring now to FIG. 6, additional elements of the system 100 will be discussed. The system 100 may further comprise a cover member 160. The cover member may be configured to be rotatably connected to the irrigation member 150 and configured to be positioned in an open position, where the center member 151 may be generally observable and accessible by a user, and a closed positioned, where the center member 151 may be generally obscured and rendered inaccessible by the user. The irrigation member 150 may further comprise a cover attachment member 159 configured to facilitate the rotatable attachment of the cover member 160 thereto. In the second position, the cover member 160 may prevent the unintended splashing of the fluid 114 out of the irrigation module 150 by interfacing with the upper section 153 of the sidewalls 151.

Referring now to FIG. 7, a plant module 700 according to an embodiment of the invention is presented. The plant module 700 may comprise an interfacing section 702 and a body section 704. The interfacing section 702 may be configured to interface with the upper surface 420 of the interfacing surface member 418 of a plant receiving member 414. When so interfaced, the body section 704 may extend through the plant-receiving aperture 426, the plant module channel 422, and the plant aperture 424 and extend into the interior vertical channel 410. The body section 704 may be configured to permit fluid to flow therethrough and into a cavity 706 defined thereby. Fluid-retaining material may be positioned within the cavity 706 and absorb fluid the flows through the body member 704, thereby enabling a plant embedded in the fluid retaining material to extract the fluid therefrom. Any known means or method of permitting such fluid flow through the body section 704 is contemplated and included within the scope of the invention. In the present embodiment, the body section 704 comprises a plurality of openings 708 configured to permit fluid to flow therethrough. The present embodiment is made from a rigid material, enabling the interfacing section 702 and the body section 704 to be integrally formed as a monolithic structure. In alternative embodiments, the body section 704 may be formed of a fluid-permeable material and attached to the interfacing section 702 by any means or method as is known in the art, including those described herein above.

An alternative embodiment of the invention may be directed to a kit comprising a system as described for the system 100 above. The kit may comprise a container, the container containing a base assembly comprising a nutrient reservoir and an upper attachment member. The kit may further comprise a pumping module comprising a fluid pump operable to pump fluid and a pump tube configured to attach to the fluid pump at a first end and permit fluid pumped by the fluid pump to flow therethrough and exit at a second end. The kit may further comprise a plurality of vertical stacking units, each vertical stacking unit comprising one or more sidewalls defining an interior vertical channel, each sidewall comprising an attachment section at a lower end thereof configured to interface with one of the upper attachment member of the base assembly and an upper portion of the sidewalls of a vertical stacking unit to removably attach the vertical stacking unit thereto. The vertical stacking units may further comprise a plant receiving member extending outward from a sidewall, the plant receiving member comprising a plant-receiving aperture configured to permit a plant module to be positioned therein and grow outward therefrom and extend into the interior vertical channel such that a portion of the plant module is in fluidic communication with the interior vertical channel. The kit may further comprise an irrigation module configured to attach to a vertical stacking unit and comprising one or more sidewalls configured to interface with the sidewalls of a vertical stacking unit, thereby removably attaching the irrigation module to the vertical stacking unit, a center member comprising one or more apertures, an inlet port extending downward from the center member and configured to facilitate the removable attachment of the second end of the pump tube thereto, and an outlet port extending upward from the center member and positioned in fluidic communication with the inlet port and configured to permit fluid flowing into the inlet pump to flow out the outlet port. The kit may further comprise a plurality of plant modules, each plant module comprising an interfacing section configured to interface with and be carried by a plant receiving member and a body section configured to permit fluid to flow therethrough. All of the above-described elements may be positioned within the container and contained thereby.

In some embodiments, the kit may further comprise a distribution member and a cover member as described above. In some embodiments the kit may further comprise a package of fluid-retaining material configured to be positioned within the body section of a plant member and a plurality of seeds configured to be positioned within fluid-retaining material positioned within the body section. In some embodiments the kit may further comprise a water-soluble nutrient solution configured to be combined with water and positioned within the nutrient reservoir and be pumped by the fluid pump. All of the above may be positioned within and contained by the container.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A vertical modular hydroponic plant growing system comprising:
a base assembly comprising:
a nutrient reservoir; and
an upper attachment member;
a pumping module comprising:
a fluid pump operable to pump fluid; and
a pump tube configured to attach to the fluid pump at a first end and permit fluid pumped by the fluid pump to flow therethrough and exit at a second end;
a plurality of vertical stacking units, each vertical stacking unit of the plurality of stacking units comprising:
one or more sidewalls defining an interior vertical channel, each sidewall comprising an attachment section at a lower end thereof configured to interface with one of the upper attachment member of the base assembly and an upper portion of the sidewalls of a vertical stacking unit to removably attach the vertical stacking unit thereto;
a plant receiving member extending outward from a sidewall, the plant receiving member comprising a plant-receiving aperture configured to permit a plant module to be positioned therein and grow outward therefrom and extend into the interior vertical channel such that a portion of the plant module is in fluidic communication with the interior vertical channel; and
an irrigation module configured to attach to a vertical stacking unit and comprising:
one or more sidewalls configured to interface with the sidewalls of a vertical stacking unit, thereby removably attaching the irrigation module to the vertical stacking unit;
a center member comprising one or more apertures;
an inlet port extending downward from the center member and configured to facilitate the removable attachment of the second end of the pump tube thereto; and
an outlet port extending upward from the center member and positioned in fluidic communication with the inlet port and configured to permit fluid flowing into the inlet pump to flow out the outlet port;
wherein the interior vertical channel of each vertical stacking unit cooperates to define a contiguous interior channel of the system; and
wherein fluid flowing out of the outlet port flows onto the upper surface of the center member and through the one or more apertures thereof into the contiguous interior channel.

2. The system of claim 1 wherein an upper surface of the center member is bounded by the one or more sidewalls of the irrigation module.

3. The system of claim 1 wherein:
the nutrient reservoir comprises a lower wall and a plurality of sidewalls; and
the upper attachment member is configured to removably attach to an upper end of the plurality of sidewalls of the nutrient reservoir.

4. The system of claim 3 wherein the upper attachment member comprises:
a first section comprising an attachment structure configured to facilitate the removable attachment of a vertical stacking unit thereto and defining an aperture; and
a second section that is one of separate from the first section and rotatably attached to the first section;
wherein the upper attachment member obstructs an upper opening of the nutrient reservoir when the second section is in a closed position and permits access to the upper opening of the nutrient reservoir when the second section is in an open position; and
wherein the aperture of the first section is configured to permit the pump tube to pass therethrough and into the contiguous interior channel.

5. The system of claim 1 wherein the attachment section of the one or more sidewalls of the vertical stacking units have an outer dimension that is less than an inner dimension of the upper portion of the sidewalls of the vertical stacking units.

6. The system of claim 1 wherein the irrigation module further comprises a cover attachment member, the system further comprising a cover member configured to rotatably attach to the cover attachment member and be positionable to interface with an upper section of the sidewalls of the irrigation module and prevent the unintentional expulsion of fluid through an open upper section of the irrigation module.

7. The system of claim 1 wherein the center member comprises a first plurality of apertures positioned proximate to the sidewalls of the irrigation module and a second plurality of apertures positioned proximate to the outlet port.

8. The system of claim 1 further comprising a distribution member configured to removably attach to the outlet port and to deflect fluid emerging from the outlet port in a substantially uniform distribution pattern.

9. The system of claim 1 wherein the plant receiving member comprises:
a body member extending upward and outward from an outer surface of a sidewall of the vertical stacking unit and defining a passageway through which the plant module may be positioned and extend into the interior vertical channel of the vertical stacking unit; and
an interfacing surface member extending outward and downward from the same outer surface of the sidewall of the vertical stacking unit as the body member, the interfacing surface comprising an upper surface thereof defining the plant-receiving aperture and configured to interface with a surface of the plant module to prevent the plant module from sliding entirely into the interior vertical channel, thereby suspending the plant module in the plant receiving member.

10. The system of claim 8 wherein the plant receiving member is integrally formed with the sidewall of the vertical stacking unit.

11. The system of claim 1 wherein each vertical stacking unit comprises a plurality of plant receiving members equal in number to the number of sidewalls comprised by the one or more sidewalls of the vertical stacking unit.

12. A vertical modular hydroponic plant growing system comprising:
a base assembly comprising:
a nutrient reservoir comprising:
a lower wall; and
a plurality of sidewalls; and
an upper attachment member configured to removably attach to an upper end of the plurality of sidewalls of the nutrient reservoir and comprising:
a first section comprising an attachment structure configured to facilitate the removable attachment of a vertical stacking unit thereto and defining an aperture; and
a second section that is one of separate from the first section and rotatably attached to the first section;
wherein the upper attachment member obstructs an upper opening of the nutrient reservoir when the second section is in a closed position and permits access to the upper opening of the nutrient reservoir when the second section is in an open position;
a pumping module comprising:
a fluid pump operable to pump fluid; and
a pump tube configured to attach to the fluid pump at a first end and permit fluid pumped by the fluid pump to flow therethrough and exit at a second end;
a plurality of vertical stacking units, each vertical stacking unit of the plurality of stacking units comprising:
a plurality sidewalls defining an interior vertical channel, each sidewall comprising an attachment section at a lower end thereof configured to interface with one of the upper attachment member of the base assembly and an upper portion of the sidewalls of a vertical stacking unit to removably attach the vertical stacking unit thereto;
a plurality of plant receiving members, each plant receiving member being integrally formed with and extending radially outward from a sidewall of the plurality of sidewalls of the vertical stacking unit, each plant receiving member comprising:
a body member extending upward and outward from an outer surface of a sidewall of the vertical stacking unit and defining a passageway through which the plant module may be positioned and extend into the interior vertical channel of the vertical stacking unit; and
an interfacing surface member extending outward and downward from the same outer surface of the sidewall of the vertical stacking unit as the body member, the interfacing surface comprising an upper surface thereof defining a plant-receiving aperture configured to permit a plant module to be positioned therein and grow outward therefrom and extend into the interior vertical channel such that a portion of the plant module is in fluidic communication with the interior vertical channel, the upper surface further being configured to interface with a surface of the plant module to prevent the plant module from sliding entirely into the interior vertical channel, thereby suspending the plant module in the plant receiving member;
an irrigation module configured to attach to a vertical stacking unit and comprising:
one or more sidewalls configured to interface with the sidewalls of a vertical stacking unit, thereby removably attaching the irrigation module to the vertical stacking unit;
a center member comprising one or more apertures;
an inlet port extending downward from the center member and configured to facilitate the removable attachment of the second end of the pump tube thereto; and
an outlet port extending upward from the center member and positioned in fluidic communication with the inlet port and configured to permit fluid flowing into the inlet pump to flow out the outlet port;
wherein the aperture of the first section is configured to permit the pump tube to pass therethrough and into the contiguous interior channel;
wherein the interior vertical channel of each vertical stacking unit cooperates to define a contiguous interior channel of the system; and
wherein fluid flowing out of the outlet port flows onto the upper surface of the center member and through the one or more apertures thereof into the contiguous interior channel.

13. The system of claim 12 wherein an upper surface of the center member is bounded by the one or more sidewalls of the irrigation module.

14. The system of claim 12 wherein the attachment section of the plurality of sidewalls of the vertical stacking units have an outer dimension that is less than an inner dimension of the upper portion of the sidewalls of the vertical stacking units.

15. The system of claim 12 wherein the attachment section of the one or more sidewalls of the vertical stacking units have an outer dimension that is less than an inner dimension of the upper portion of the sidewalls of the vertical stacking units.

16. The system of claim 12 wherein the irrigation module further comprises a cover attachment member, the system further comprising a cover member configured to rotatably attach to the cover attachment member and be positionable to interface with an upper section of the sidewalls of the irrigation module and prevent the unintentional expulsion of fluid through an open upper section of the irrigation module.

17. The system of claim 12 wherein the center member comprises a first plurality of apertures positioned proximate to the sidewalls of the irrigation module and a second plurality of apertures positioned proximate to the outlet port.

18. The system of claim 12 further comprising a distribution member configured to removably attach to the outlet port and to deflect fluid emerging from the outlet port in a substantially uniform distribution pattern.

19. A vertical modular hydroponic plant growing system kit comprising:
a container;
a base assembly comprising:
a nutrient reservoir; and
an upper attachment member;
a pumping module comprising:
a fluid pump operable to pump fluid; and
a pump tube configured to attach to the fluid pump at a first end and permit fluid pumped by the fluid pump to flow therethrough and exit at a second end;
a plurality of vertical stacking units, each vertical stacking unit of the plurality of stacking units comprising:
one or more sidewalls defining an interior vertical channel, each sidewall comprising an attachment section at a lower end thereof configured to interface with one of the upper attachment member of the base assembly and an upper portion of the sidewalls of a vertical stacking unit to removably attach the vertical stacking unit thereto;
a plant receiving member extending outward from a sidewall, the plant receiving member comprising a plant-receiving aperture configured to permit a plant module to be positioned therein and grow outward therefrom and extend into the interior vertical channel such that a portion of the plant module is in fluidic communication with the interior vertical channel;
an irrigation module configured to attach to a vertical stacking unit and comprising:
one or more sidewalls configured to interface with the sidewalls of a vertical stacking unit, thereby removably attaching the irrigation module to the vertical stacking unit;
a center member comprising one or more apertures;
an inlet port extending downward from the center member and configured to facilitate the removable attachment of the second end of the pump tube thereto; and
an outlet port extending upward from the center member and positioned in fluidic communication with the inlet port and configured to permit fluid flowing into the inlet pump to flow out the outlet port; and
a plurality of plant modules, each plant module comprising:
an interfacing section configured to interface with and be carried by a plant receiving member; and
a body section configured to permit fluid to flow therethrough.

20. The kit of claim 19 wherein the irrigation module further comprises a cover attachment member, the kit further comprising:
a distribution member configured to removably attach to the outlet port and to deflect fluid emerging from the outlet port in a substantially uniform distribution pattern; and
a cover member configured to rotatably attach to the cover attachment member and be positionable to interface with an upper section of the sidewalls of the irrigation module and prevent the unintentional expulsion of fluid through an open upper section of the irrigation module.
